(19) United States
(12) Patent Application Publication
(10) Pub. No.: US 2007/0124077 A1
(43) Pub. Date: May 31, 2007

(54) An Inventory Stocking and Locating System Utilizing Tags and GPS providing Summarization by Hierarchical Code

(75) Inventor: Robert G Hedlund JR., Dunedin, FL (US)

Correspondence Address: ROBERT G. HEDLUND, 1460 BURNHAM LN., DUNEDIN, FL, 34698-3213, US

(73) Assignee: Robert G. Hedlund JR., Dunedin, FL (US)

(21) Appl. No.: 11/164,623

(22) Filed: Nov. 30, 2005

(51) Int. Cl. G06G 7/78

(52) U.S. Cl. 701/300

(57) ABSTRACT

Objects (SKUs) are tagged with standard data, including an identifier. The tag is readable by a device such as a scanner or radio receiver. As these objects are inventoried, the tags are read by fixed or hand-held readers that are equipped to append GPS coordinates (4D data) to the tag data. These objects may also be summarized by identifier. This information is subsequently transferred to a client node computer where it is further summarized into a hierarchical scheme such as commodity code. Each object is coded to indicate its usage (in reserve, available, private, hidden, etc.). A database index composed of commodity code, quantity and a usage code is built and published to a network on a defined schedule. A second database of stocking entity names and 4D locations is also established, published and updated by the site administrator as needed. Commodities are networked through a global system of increasing levels of summation. The base (root) level represents the most general commodity code and the greatest level of summation. A means is provided for physically locating the objects within a site. A means is provided to source commodities globally using the network and to determine the location of the nearest stocking entity.

### BACKGROUND OF THE INVENTION

1. Field of Invention

The present invention relates generally to improved methods of and apparatus for identifying objects, such as pallets and cartons, during inventory operations, and also to improved methods of and apparatus for locating such objects. Further, an improved method publishing and searching for inventoried objects is provided.

2. Brief Description of the State of Knowledge in the Art

The use of image-based bar code symbol readers and scanners is well known in the field of auto-identification. The use of radio frequency identification tag readers is also well known in the field of auto-identification. Examples of such systems include, for example, hand-hand scanners, point-of-sale (POS) scanners, and industrial-type conveyor scanning systems.

Presently, most GPS technology is used for locating persons or vehicles in motion or for routing and as an assistance to navigation. The data GPS makes available may be used in other ways as: providing information about the current locale (attractions, restaurants), for timing in games or competitions, treasure hunts or rallying.

Supply chain management (SCM) software such as the SCM solutions provided by SAP AG of Walldorf, Germany, enable a user to manage materials, information, and finances as they move in a process from a supplier to a manufacturer to a wholesaler to a retailer. The SCM software generally includes databases for tracking the physical status of the goods, the management of materials, and financial information.

Inventory management is a component of most SCM systems. Inventory management enables suppliers to keep track of how much inventory they have and how much inventory they have distributed to particular retailers. Periodically, the retailer reports to the supplier the current inventory level of the store. Based on the report, the supplier determines whether the store inventory needs to be replenished.

However, the prior art generally fails to disclose, teach or suggest how such prior art techniques might be successfully integrated into a consistent and easily accessable system.

Thus, there is a great need in the art for an improved method of and apparatus for capturing object data and location data during inventory operations, and also an improved method of and apparatus for locating said objects for further operations, while avoiding the shortcomings and drawbacks of prior art recording and scanning systems and related methodologies.

### SUMMARY AND OBJECT OF THE PRESENT INVENTION

The present subject matter relates generally to computerized systems or networks interconnecting systems that process inventory objects in storage facilities. More particularly, the present subject matter relates to the collection of data and information on apparatus and systems, the transmission of the collected data to a centralized computer or computerized apparatus, and the manipulation, processing and accessing of the collected data through web pages by authorized users interfacing via web browser applications or programs on user computers or other client devices.

Further, a primary object of the present invention is to provide a method for combining available technology in a novel fashion and system for employing the new device to record the identity and location of objects during inventory operations and also improved methods of and systems for capturing, storing, indexing and retrieving such object information.

The drawing figures depict one or more implementations in accord with the present concepts, by way of example only, not by way of limitations. The description may be better understood when read in connection with the accompanying drawings.

The subject matter has been described and illustrated with respect to certain preferred aspects by way of example only. Those skilled in that art will recognize that the preferred examples or aspects may be altered or amended without departing from the inventive spirit and scope of the subject matter. Therefore, the subject matter is not limited to the specific details, representative devices, and illustrated examples in this description. The novel subject matter is limited only by the following claims and equivalents.

The present invention relates to computer systems for the management of information distributed across a plurality of electronic system devices. More particularly, the invention relates to a system which includes a plurality of network servers, interface nodes and remote data collecting devices to facilitate information collection and storage such that the location of specific objects can be recorded and later accessed. The invention also relates to information storage, indexation and retrieval methods.

As an initial matter, in the interest of simplifying this explanation and unless indicated otherwise, the description which follows describes the invention in the context of a warehouse. However, it should be recognized that the invention should not be so limited and clearly has applications which are outside warehousing, only some of which are specifically discussed hereinafter.

In many industries a need exists for collection and storage of information about the location of objects which provides subsequent information retrieval. For example, in warehouses there is a need, for the collection, storage, and retrieval of information about objects in stock known as stock keeping units (SKUs).

Inventory management systems (IMS) have evolved over time to facilitate warehouse administration. These systems provide information about SKUs. The minimum information provided is the identity of the SKU, the quantity available, and where the SKU is stored. Many variants on this theme are in general use. They all lack a global standard which has hindered their implementation and operation. By standardizing location coding, a major source of confusion and error can be eliminated. By standardizing SKU categorization using class code, interoperability across facilities and companies can be facilitated.

A typical IMS requires that an SKU be counted, physically placed in a bin in the warehouse, the location identifier (row, aisle, and bin) be noted and the three elements (SKU quantity, SKU identification code, and location) be recorded on a computer. The IMS will provide for the publication of this information in various formats. The IMS will allow for changes to inventoried SKU counts either by a transaction scheme (e.g., adding items received and subtracting items shipped out) or by the operator going to the bin location and counting the SKUs periodically or a combination of these methods.

While this approach has allowed a greater span of control than manual systems, it results in a complex system wherein it is often difficult to share information outside the facility. This is because a single facility, or related facilities, may employ different SKU identification schemes, different location identification schemes and an enterprise may have several different physical locations.

As modern management practices have embraced just-in-time delivery and supply chain management, internet and extranet based solutions have become increasingly important. This requires the sharing of IMS data among businesses as well as facilities and creates issues of scale with attendant issues of data accessibility. Further, SKU identifiers are not necessarily standard and are not designed for aggregation. While these concerns are well known, the solutions so far have been adhoc(Electronic Data Interchange, the XML language) and complicated.

While such IMS systems can usually meet the information gathering needs of a single enterprise, current systems have a number of shortcomings.

First, information-gathering and entry into such a system are extremely time consuming and therefore are often thought of as onerous tasks. The operator must code both the location and the SKU, or use a (potentially lengthy) printed or electronic check-list. Each method either increases the likelihood of errors or reduces the timeliness of the data or both.

Second, because inventory identifiers are often unique to a enterprise or stocking entity, they cannot be used to answer inquiries from customers.

Third, in addition to providing for queries within a entity, there is often a need to search for inventory closest to a customer's location. This usually requires a multiplicity of data sources including maps, lists of SKUs, and item identifier exchange charts.

### BRIEF SUMMARY OF THE INVENTION

The present invention relates to an information gathering system wherein a Geo Location Information Tag Reader (GLITR) is equipped to remotely and electronically collect a large portion of the information that identifies stock at a entity. On completion of the gathering function, data is transferred to a client node computer. This computer or a master (inventory) computer, by reference to a file of standards, will categorize and aggregate the data into a summary database. This database may be re-aggregated by department, facility, division or enterprise and published to a public network. A method is proposed for the indexation and retrieval of this data globally.

One object of the invention is to reduce the amount of manual data entry. Another is to simplify information management. To these ends, the inventive GLITR facilitates automated electronic entry of data. All SKUs are associated with absolute GPS 4D coordinates (Cf., World Geodetic System—1984: WGS84). The coordinates of 4D are latitude, longitude, elevation and time. Latitude and longitude may be represented in degrees, minutes and seconds, decimal degrees or some grid system. Elevation may be represented as metric distance to earth center. Time may be recorded in Universal Metric Time (UMT). Also, a numeric key pad may be used by the operator to enter quantities, if needed (for work in progress, open cartons, high value SKUs).

When an SKU tag is read by the GLITR processor, the GLITR processor provides 4D information read from a satellite, wireless network, cellular telephone tower, or other broadcast point of calibrated location and time. The 4D information and, if desired an entered quantity, is then appended to information from the tag to create a packet. The information packets are transferred from the GLITR to a client node on an inventory network. The data is further processed and retained on a master inventory computer. The collection of these records will then provide the absolute location of the SKUs in the facility. This location information may be used to count, value or direct physical retrieval of the SKUs.

To be suitable for use with the inventive GLITR, a system must include at least one, and preferably several, client node computers, a master inventory computer and a network to join them. A file consisting of the data collected from the GLITR(s) will be maintained on each node; and all of the nodes' data will be collected to a database on the master inventory computer. The master inventory computer may publish information to a classical IMS (as described above). The master inventory computer is intended to publish the data to a computer (Internet server) which, in turn, publishes to the Internet or other public network (infra).

The public network server functions as the facility node on a public network, which is designated the World Wide Commodity Locater net (WWCL) The WWCL is to be composed of a hierarchical system of servers at various levels of service. As the level number decreases, the level of aggregation increases. The final or root server level would have a single entry representing the entire global stock of each commodity type (as reported to the WWCL network). Thus, the highest or facility node might report 100 L frozen apple juice, 200 L fresh apple juice, etc. An intermediate level might report 300 L of apple juice. The root level might report 300,000,000 L of preparations of vegetables and fruit.

By reference to the stocking entity identification data, the geographical location of the entity may be associated with the commodities. This data could be used to re-aggregate data by region (report much apple juice is stored in Oregon).

Another goal is to provide information in a standard format so that all commonly trained operators can gather and use the information. To this end, the data collected is always provided and stored in the same format.

One of the central features of this invention is the use of a network to index or find the physical location of the datum and, by implication, the SKU. One extension of this property of the invention would be matching luggage to passengers on airplanes.

### BRIEF DESCRIPTION OF THE SEVERAL VIEWS OF THE DRAWINGS

FIG. 1 is a modular design for a Geo Location Information Tag Reader Geo Location Information Tag Reader (GLITR);

FIG. 2 is a view of a Geo Location Information Tag Reader (GLITR);

FIG. 3 is a view of a Geo Location Information Tag Reader (GLITR) in connected to a client node via a docking station;

FIG. 4 is a view of a keypad and light system that may be added to the GLITR;

FIG. 5 is a modular design for an enhanced Geo Location Information Tag Reader (GLITR);

FIG. 6 is a view of an enhanced system (GLITR) with a display;

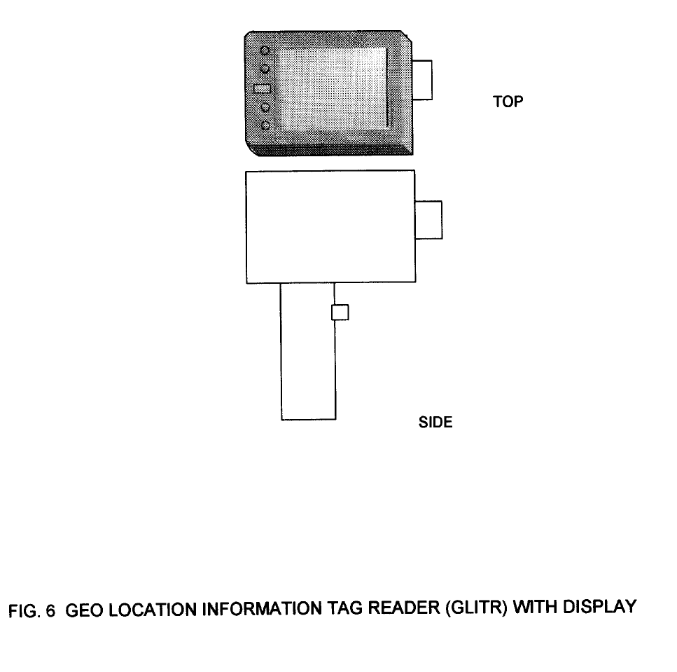

FIG. 7 is a modular design for a fixed position GLITR.

FIG. 8 is a view of a fixed position GLITR connected to a local network;

FIG. 9 depicts a traditional warehouseman taking inventory;

FIG. 10 represents a local inventory management network;

FIG. 11 represents the data transferred from the client node(s) to the inventory master computer;

FIG. 12 represents the commodity code network;

FIG. 13 shows a hierarchical commodity code (based on Schedule B) with aggregation.

FIG. 14 represents the world wide entity location network;

FIG. 15 is an example of 4D GPS notation;

FIG. 16 is an example of a query by commodity code;

FIG. 17 is an example of a query by stocking entity.

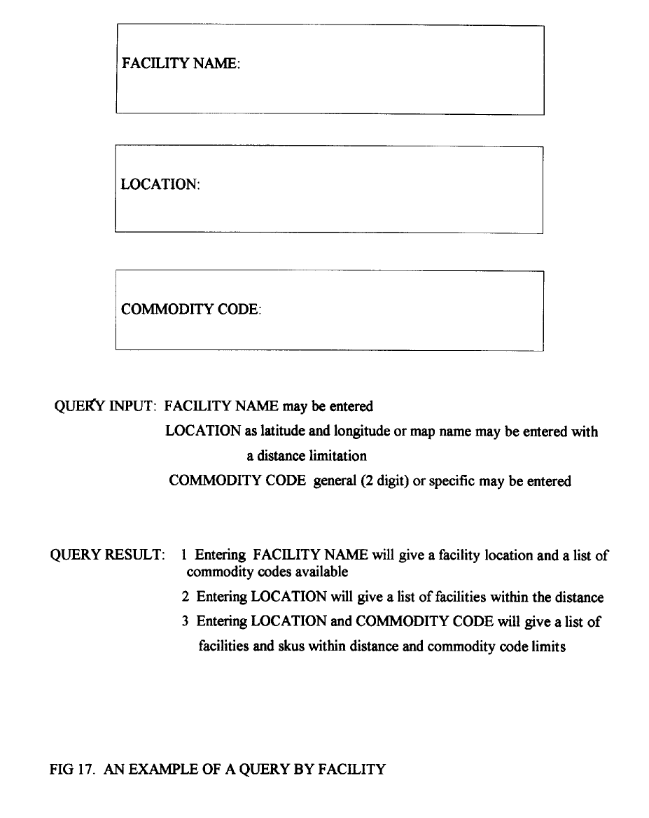

### DETAILED DESCRIPTION OF THE INVENTION

The invention may be adapted for use in a wide variety of applications and is suitable for any environment in which numerous data records having one or multiple formats are to be identified, indexed or retrieved. By way of illustration and not by way of limitation, unless indicated otherwise, the preferred embodiment is presented in the context of a warehouse environment in which a computer system is used.

I. The Geo-Location Information Tag Reader (GLITR)

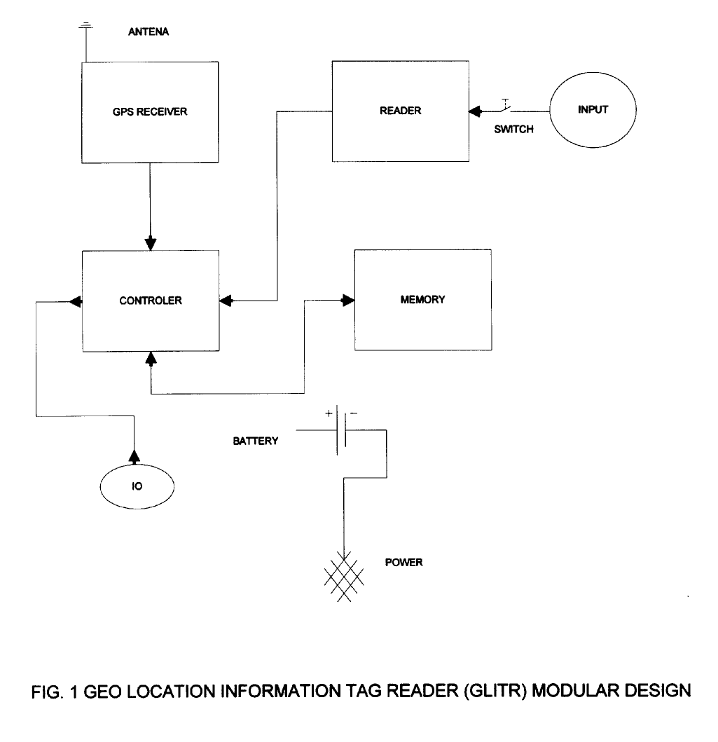

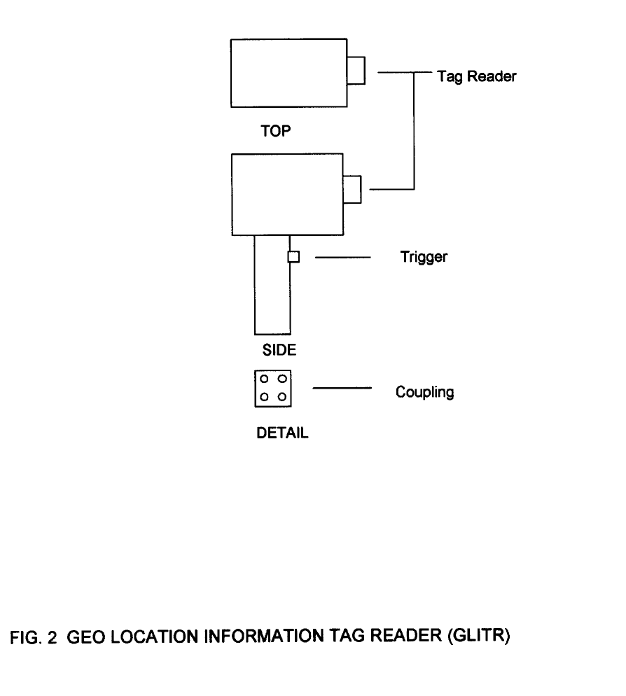

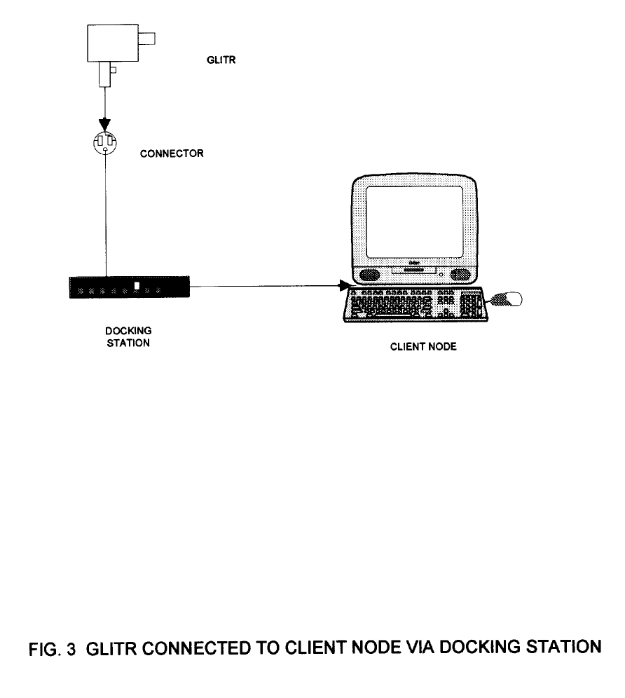

The Geo-Location Information Tag Reader (GLITR) is made up of a GPS module, a tag reader module (bar-code, radio frequency identification) with an on-off switch, memory, a rechargeable battery, and a means of communication with the inventory client node (FIG. 1). The GLITR is intended to be packaged in a user-friendly housing (FIG. 2). One or two-way communication with the inventory client node may be effected by means of a coupling or docking station (via USB, RS232c, IEEE1394, etc.) or by various wireless transmission schemes (WIFI, Bluetooth, etc.). The docking station may be used to transfer data and to charge the battery (FIG. 3).

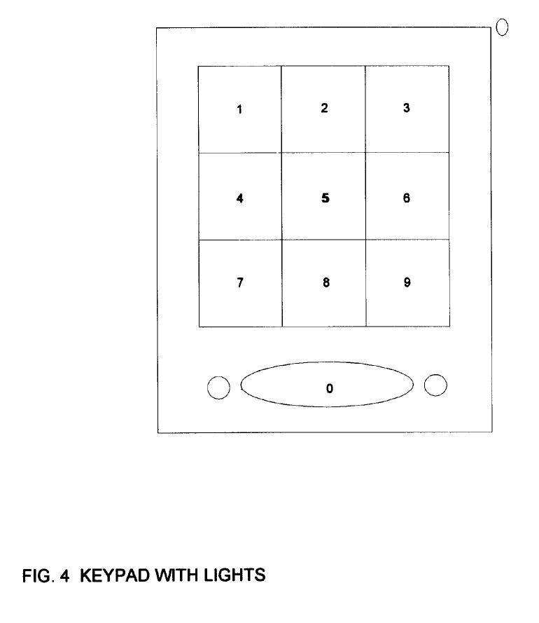

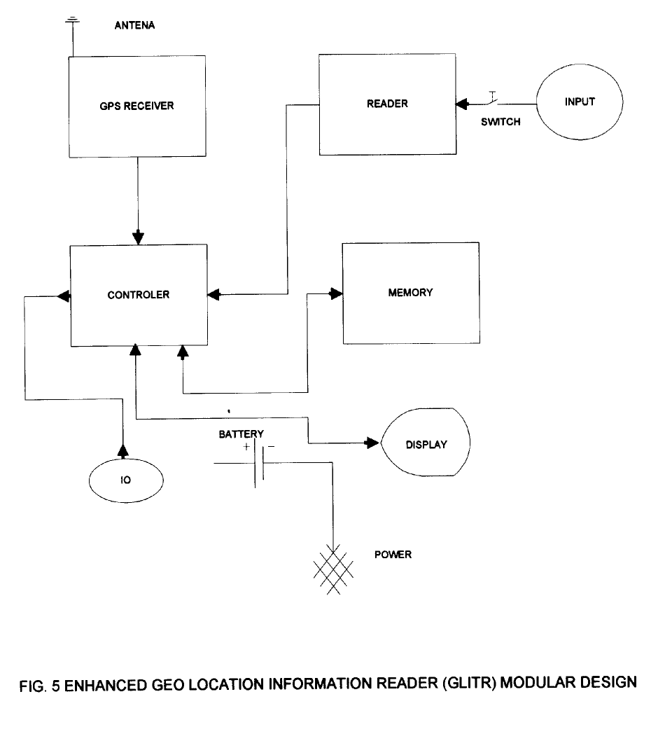

Variants of the basic GLITR include: addition of a numeric key-pad to enter quantities and addition of computational logic and a light or tone to indicate operation status (FIG. 4). An enhanced GLITR includes a display (FIGS. 5 & 6) to guide in accessing stock (described below).

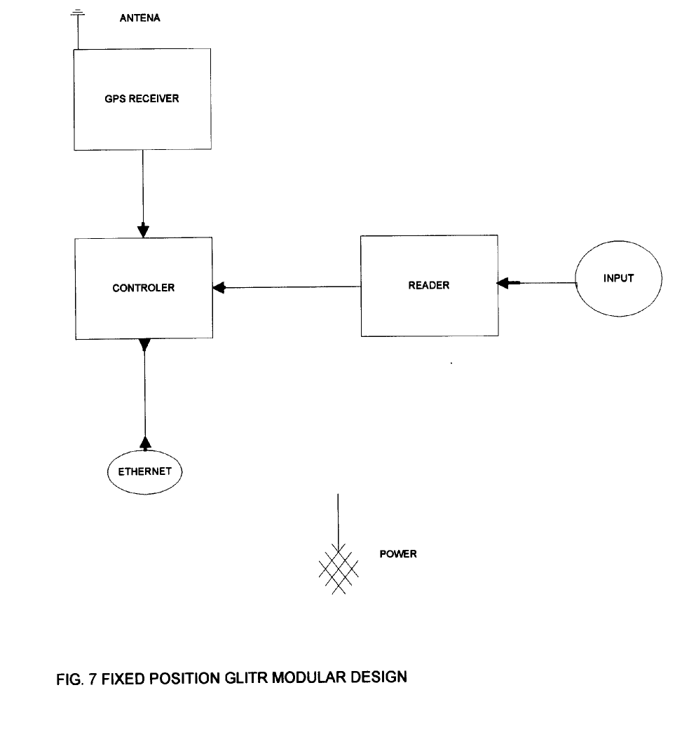

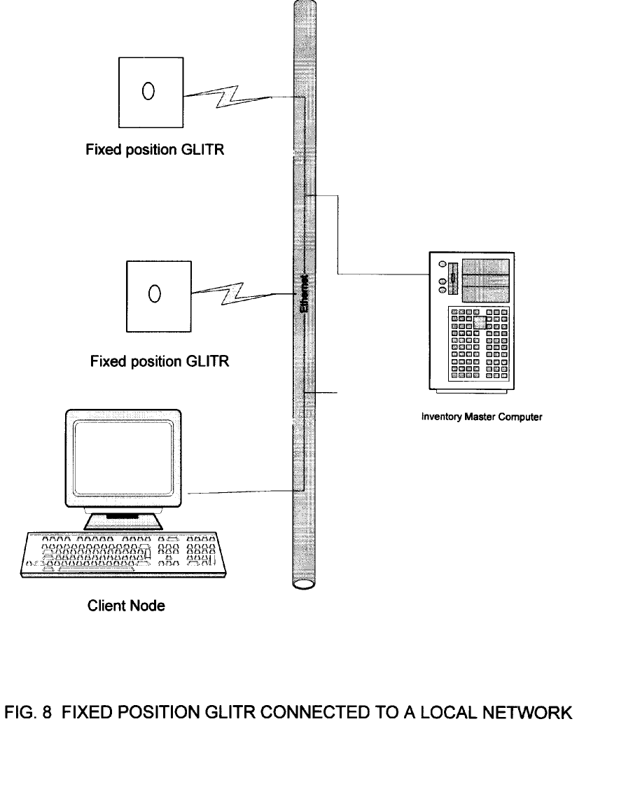

A fixed position GLITR for constantly or periodically monitoring the presence of items at a specific location is also described. The fixed GLITR consists of a GPS module, a tag reader module, a connection to the network or client node, and a power source or supply (FIG. 7). The fixed position GLITR may be equipped with a signal, such as a light, to alert operators of its status (FIG. 8).

II. A GLITR Collecting Data

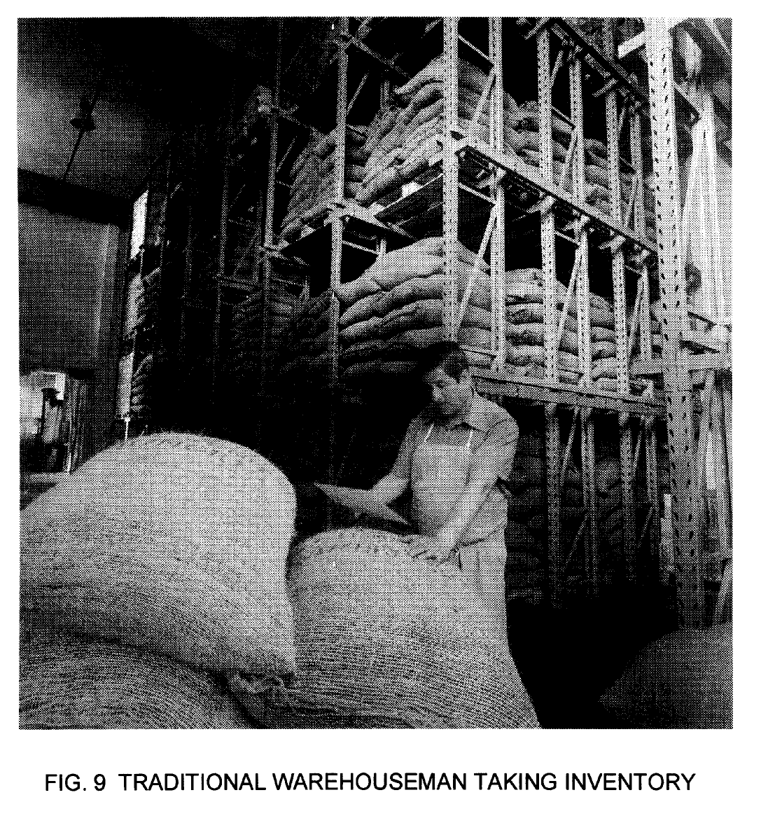

FIG. 9 depicts a warehouseman gathering data from printed tags and writing the information on paper. This operation is replaced by the GLITR as described here. The operator brings the GLITR near the SKU as it rests in its storage location (bin). The operator then presses the switch to read the tag. The GLITR records the tag data and the 4D (GPS) data. This operation is repeated until all the SKUs are recorded. In some applications, the operator may use a keypad to record the quantity of a given SKU in a bin.

III. A GLITR Exchanging Data

FIG. 3 describes the operation of a GLITR in exchanging data with client node systems. GLITR may utilize alternate communication means, such as infrared, magnetic coupling or low power radio transmission, rather than the direct connection means of the GLITR depicted. Regardless of the means of communication used, the data record that is transmitted by the GLITR is consistent. It is formatted is a manner consistent with the Open Document file format.

III. GLITR used to Guide Operator

Referring again to FIGS. 5 & 6, an embodiment of the GLITR intended to assist in locating items. This type of GLITR is essentially identical to the GLITR of FIG. 1, sharing internal components but including memory capable of loading route maps, computational module(s) to monitor the route and a display. This GLITR is intended to facilitate guiding the operator to a series of bins to locate SKUs for various purposes (counting, shipping). Software on the inventory client node is used to create a list of SKUs and to select the optimal route through the entity in order to visit each of the locations that are associated with the designated SKUs. These data are then loaded onto the GLITR. The operator uses the display on the GLITR to guide him/her to the desired items.

IV. Facility Inventory System

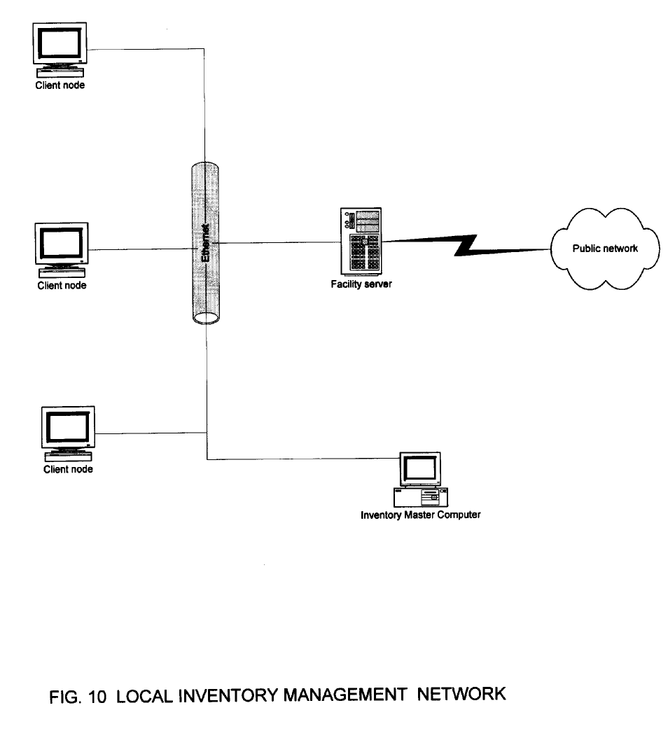

Referring to FIG. 10, a simplified example of a system used with the present invention is illustrated as a computer network. The system includes a number of computers or computer terminals comprising client nodes (located in a warehouse or administrative office thereof), a number of network devices (including databases) and a master (inventory) computer. A server sending data to the public network completes the system.

For the most part, system components communicate with each other via a communication network which may comprise a combination of local and wide area networks, using Ethernet, serial line, token ring, wireless, or other communication standards. The functions performed by the various components of the preferred embodiment of the system may be divided among multiple computer systems or consolidated into fewer components.

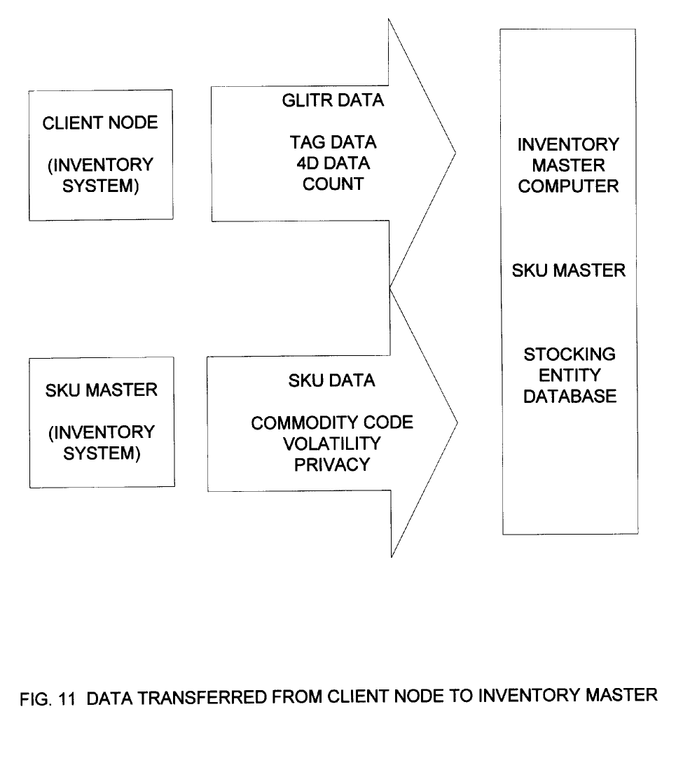

The client node computers contain files of data collected by the operative GLITR. Refer to FIG. 11 for a graphic representation of the data flow. The data from these files is summarized and coded using a database of basic SKU information. This database is often called an SKU master, an item master or a part master. It usually resides on the inventory master computer. The database includes: SKU identifier, a hierarchical class code, a volatility indicator describing how frequently this class should be recounted, a privacy code, and number of items in this unit (24 per carton, six-pack).

The summary data is used to create an index entry in a stocking database. One such database is created at each stocking entity (warehouse, factory, retail store). The stocking entity database consists of commodity code, total quantity, 4D data and codes (security, privacy, usage).

Data collected by the system described may be transferred to an IMS such as described in the Background Section above. The GLITR derived data is summarized as desired by an enterprise and used to create an enterprise database which is published to the WWCL. The elements of the enterprise database are the same as those of the stocking entity database.

V. The Class Code Hierarchy Network

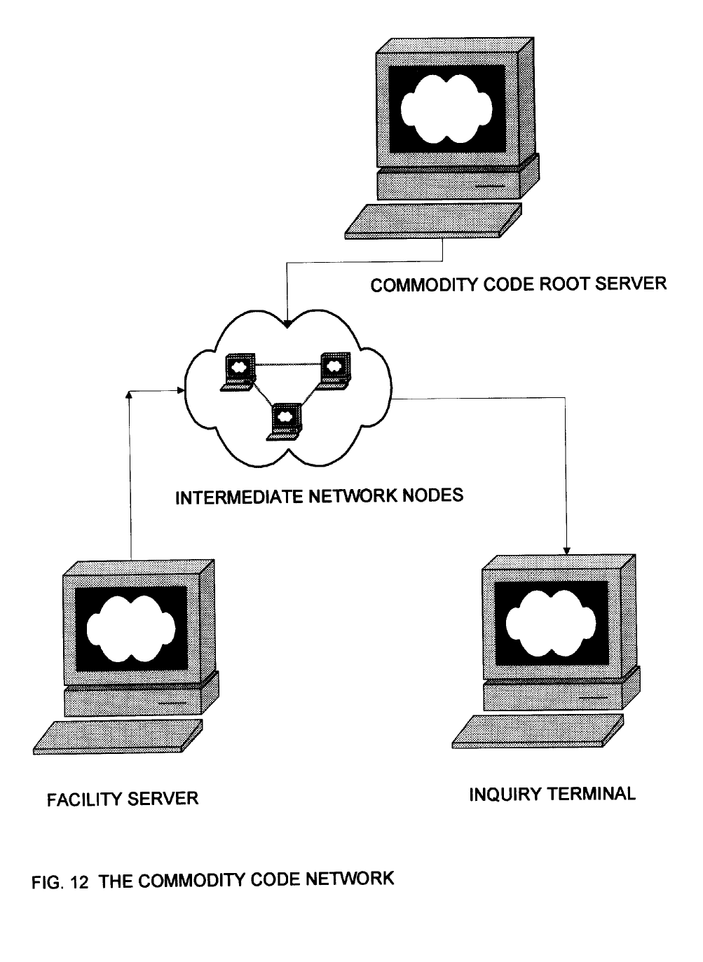

Refer to FIG. 12 for a simplified example of a hierarchal network system. The system includes a number of network computers, a network, databases and a server. Network nodes are defined by level where each level represents a more general commodity and aggregates a larger sub-class of objects.

VI. An Example of Commodity Code and Aggregation

Every 10-digit item is part of a series of progressively broader product categories. For example, concentrated frozen apple juice is assigned a 10-digit identifier that is aggregated into a broader category assigned a 6-digit identifier described as apple juice. The 6-digit identifier described as apple juice is aggregated into a broader category assigned a 4-digit identifier described as fruit juices and vegetable juices. The 4-digit identifier is further aggregated into a broader category assigned a 2-digit identifier described as Preparations of Vegetables, Fruit, Nuts, etc.

U.S. Census Bureau, foreign trade statistics, schedule B

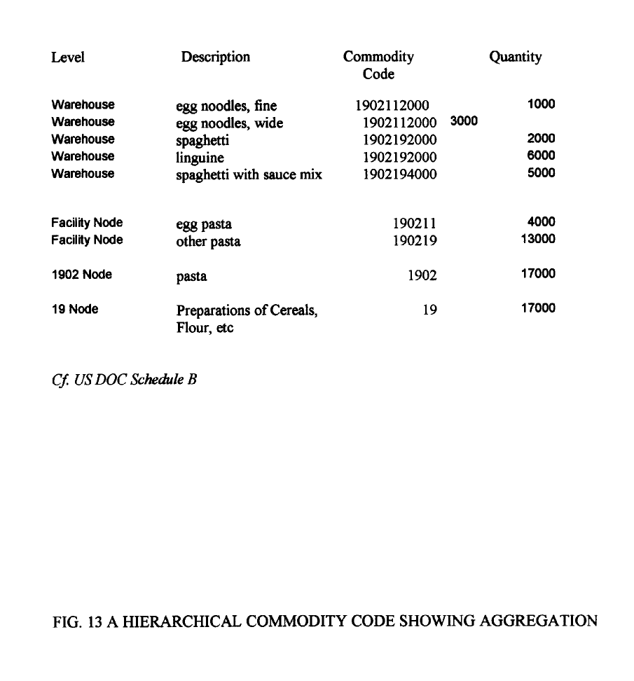

Refer to FIG. 13 for an example of commodity code and its use to aggregate objects.

VI. The Entity Location Network

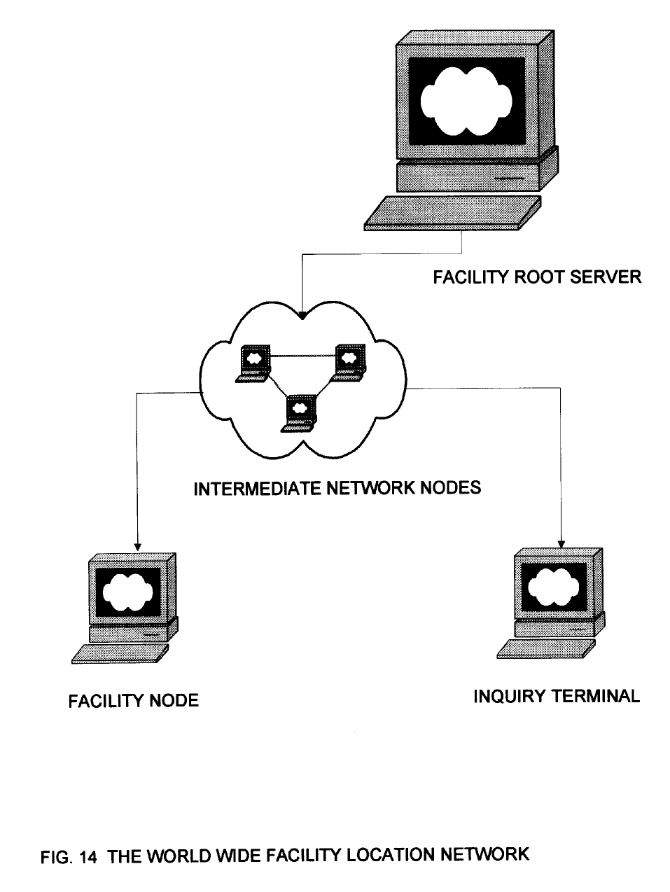

Refer to FIG. 14 for a simplified example of a entity location network system. The system includes a number of network computers, a number of network devices (including databases) and servers. This function may be supplied by the existing World Wide Web (Internet).

VII. An Example of 4D Coordinates

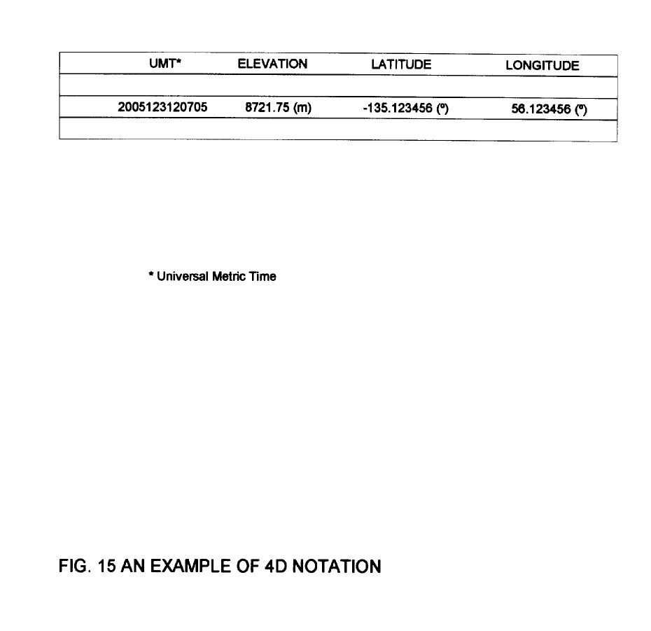

Refer to FIG. 15 for an example of 4D GPS coordinates. The 4D system uses Universal Metric Time. The 4D system further uses earth centered elevation, latitude and longitude. Elevation is given in meters. Latitude and longitude are given in decimal degrees + and − the prime meridian for North and South.

VIII. An Example of a Query

Queries may be initiated by different departments within an enterprise. During the course of business, sales, production, purchasing, and accounting may wish to know the quantity of a given SKU and its location(s) in the warehouse. Customers and vendors may wish to know aggregate data about a specific seller or about all sellers within 20 km of their own location. Interested parties may wish to know the stocking locations of volatile pesticides proximate to evacuation routes in a city. Customers or vendors may wish to contact a specific stocking entity.

Queries may be made by specifying a commodity code to the desired degree of specificity from most general (2 digits) to the most specific (10 digits). Queries may be made by SKU number to restrict the result: a general query for all steel SKUs in the world might give a very large result. Most queries will specify a location (using city, state and country; latitude and longitude; postal code; etc.). Queries may be made for entity information in order to contact an entity representative as needed.

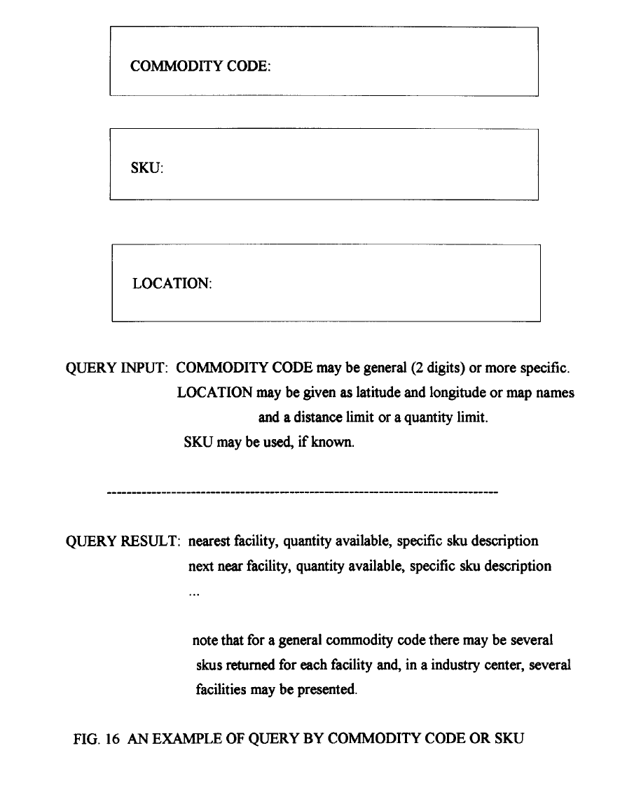

Refer to FIGS. 16 & 17 for examples of queries.

Definition List 1

| Term | Definition |
|---|---|
| 4D | The GPS architecture provides the |
| | inherent capability to solve for a four- |
| | dimensional solution (latitude, |
| | longitude, elevation and time). |
| Barcode | A barcode (also bar code) is a machine- |
| | readable representation of information |
| | in a visual format on a surface. |
| | Originally barcodes stored data in the |
| | widths and spacings of printed parallel |
| | lines, but today they also come in |
| | patterns of dots, concentric circles, |
| | and hidden in images. Barcodes can be |
| | read by optical scanners called barcode |
| | readers or scanned from an image by |
| | special software. Barcodes are widely |
| | used to implement Auto ID Data Capture |
| | (AIDC) systems that improve the speed |
| | and accuracy of computer data entry. |
| Bluetooth | Bluetooth is an industrial specification |
| | for wireless personal area networks |
| | (PANs). Bluetooth provides a way to |
| | connect and exchange information between |
| | devices like personal digital assistants |
| | (PDAs), mobile phones, laptops, PCs, |
| | printers and digital cameras via a |
| | secure, low-cost, globally available |
| | short range radio frequency. |
| EDI | Electronic Data Interchange (EDI) is the |
| | computer-to-computer exchange of |
| | structured information, by agreed |
| | message standards, from one computer |
| | application to another by electronic |
| | means and with a minimum of human |
| | intervention. In common usage, EDI is |
| | understood to mean specific interchange |
| | methods agreed upon by national or |
| | international standards bodies for the |
| | transfer of business transaction data, |
| | with one typical application being the |
| | automated purchase of goods and |
| | services. |
| Ethernet | Ethernet is a frame-based computer |
| | networking technology for local area |
| | networks (LANs). The name comes from the |
| | physical concept of ether. It defines |
| | wiring and signaling for the physical |
| | layer, and frame formats and protocols |
| | for the media access control (MAC)/data |
| | link layer of the OSI model. Ethernet is |
| | mostly standardized as IEEEs 802.3. It |
| | has become the most widespread LAN |
| | technology in use during the 1990s to |
| | the present, and has largely replaced |
| | all other LAN standards such as token |
| | ring, FDDI, and ARCNET. |
| GPS | The Global Positioning System, usually |
| | called GPS (the US military refers to it |
| | as NAVSTAR GPS - Navigation Signal |
| | Timing and Ranging Global Positioning |
| | System), is a satellite navigation |
| | system used for determining one's |
| | precise location and providing a highly |
| | accurate time reference almost anywhere |
| | on Earth or in Earth orbit. It uses an |
| | intermediate circular orbit (ICO) |
| | satellite constellation of at least 24 |
| | satellites. |
| IEEE 1394 | IEEE 1394 (also known as FireWire) is a |
| | personal computer and digital video |
| | serial bus interface standard offering |
| | high-speed communications and |
| | isochronous real-time data services. |
| | FireWire can be considered a successor |
| | technology to the obsolescent SCSI |
| | Parallel Interface. Up to 63 devices can |
| | be daisy-chained to one FireWire port. |
| information retrieval | Automated information retrieval (IR) |
| | systems were originally used to manage |
| | information explosion in scientific |
| | literature in the last few decades. Many |
| | universities and public libraries use IR |
| | systems to provide access to books, |
| | journals, and other documents. IR |
| | systems are often related to object and |
| | query. Queries are formal statements of |
| | information needs that are put to an IR |
| | system by the user. An object is an |
| | entity which keeps or stores information |
| | in a database. User queries are matched |
| | to documents stored in a database. A |
| | document is, therefore, a data object. |
| | Often the documents themselves are not |
| | kept or stored directly in the IR |
| | system, but are instead represented in |
| | the system by document surrogates. |
| Internet | The Internet, or simply the Net, is the |
| | publicly accessible worldwide system of |
| | interconnected computer networks that |
| | transmit data by packet switching using |
| | a standardized Internet Protocol (IP) |
| | and many other protocols. It is made up |
| | of thousands of smaller commercial, |
| | academic, domestic and government |
| | networks. It carries various information |
| | and services, such as electronic mail, |
| | online chat, and the interlinked web |
| | pages and other documents of the World |
| | Wide Web. |
| JIT | Just In Time (JIT) is an inventory |
| | strategy implemented to improve the |
| | return on investment of a business by |
| | reducing in-process inventory and its |
| | associated costs. |
| Query | In information retrieval, a query is a |
| | statement of information needs, |
| | typically keywords combined with boolean |
| | operators and other modifiers. |
| RFID | Radio Frequency IDentification (RFID) is |
| | an automatic identification method, |
| | relying on storing and remotely |
| | retrieving data using devices called |
| | RFID tags or transponders. An RFID tag |
| | is a small object that can be attached |
| | to or incorporated into a product, |
| | animal, or person. RFID tags contain |
| | antennas to enable them to receive and |
| | respond to radio-frequency queries from |
| | an RFID transceiver. Passive tags |
| | require no internal power source, |
| | whereas active tags require a power |
| | source. |
| Root | A root node is a specially chosen node |
| | in a tree data structure at which all |
| | operations on the tree begin. It is not |
| | the child of any other node, and all |
| | other nodes can be reached from it by |
| | following edges or links. In diagrams, |
| | it is typically drawn at the top. In |
| | some trees, such as heaps, the root node |
| | has special properties. Every node in a |
| | tree can be seen as the root node of the |
| | subtree rooted at that node. |
| RS-232 | In telecommunications, RS-232 is a |
| | standard for serial binary data |
| | interconnection between a DTE (Data |
| | terminal equipment) and a DCE (Data |
| | communication equipment). It is commonly |
| | used in computer serial ports. |
| SKU | A Stock Keeping Unit (SKU) is an |
| | identifier used for management of an |
| | inventory. The acronym SKU is used |
| | almost exclusively when talking about |
| | this concept. Furthermore, it's |
| | pronounced as a word (skyü), rather than |
| | three letters, as if you were saying the |
| | English word skew. Merchants assign SKUs |
| | to every product they sell (as opposed |
| | to the EAN or GTIN bar code number which |
| | is assigned by the manufacturer). This |
| | SKU is then used to order, locate and |
| | manage the inventory of a product. |
| | Successful inventory management systems |
| | assign a unique SKU for each product and |
| | also for its variants. For example, |
| | different flavours or models of product, |
| | or different bundled packages including |
| | a number of related products, have |
| | independent SKUs. This allows merchants |
| | to track, for instance, whether blue |
| | shirts are selling better than green |
| | shirts. |
| Supply chain | Supply chain is a business process that |
| | links suppliers, manufacturers, |
| | warehousing, logistics, retailers and |
| | the end customer in the form of a linear |
| | integrated skill and resource pool with |
| | the aggregated goal of delivering a |
| | product or service. It encompasses all |
| | activities and the flow of information |
| | both upstream and downstream the chain |
| | and is associated with the |
| | transformation of a product from raw |
| | materials through to a finished product. |
| USB | Universal Serial Bus (USB) provides a |
| | serial bus standard for connecting |
| | devices, usually to a computer. The |
| | design of USB is standardized by the USB |
| | Implementers Forum (USB-IF), an industry |
| | standards body incorporating leading |
| | companies from the computer and |
| | electronics industries. Notable members |
| | have included Apple Computer, Hewlett- |
| | Packard, NEC, Microsoft, Intel, and |
| | Agere. |
| Warehouse | A warehouse is a commercial building for |
| | storage of goods. Warehouses are used by |
| | manufacturers, importers, exporters, |
| | wholesalers, transport businesses, |
| | customs, etc. They are usually large |
| | plain buildings in industrial parts of |
| | towns. |
| World Geodetic | The International Terrestrial Reference |
| System 1984 (WGS-84) | System (ITRS) describes procedures for |
| | creating reference frames suitable for |
| | use with measurements on or near the |
| | Earth's surface. This is done in much |
| | the same way that a physical standard |
| | might be described as a set of |
| | procedures for creating a realization of |
| | that standard. The IERS defines a |
| | geocentric system of coordinates using |
| | the SI system of measurement. |
| Wi-Fi | Wi-Fi (sometimes written Wi-fi, WiFi, |
| | Wifi, wifi) is a trademark for sets of |
| | product compatibility standards for |
| | wireless local area networks (WLANs). |
| | Wi-Fi was intended to allow mobile |
| | devices, such as laptop computers and |
| | personal digital assistants (PDAs) to |
| | connect to local area networks, but is |
| | now often used for Internet access and |
| | wireless VoIP phones. Desktop computers |
| | can also use Wi-Fi, allowing offices and |
| | homes to be networked without expensive |
| | wiring. |
| XML | The Extensible Markup Language (XML) is |
| | a W3C-recommended general-purpose markup |
| | language for creating special-purpose |
| | markup languages. It is a simplified |
| | subset of SGML, capable of describing |
| | many different kinds of data. Its |
| | primary purpose is to facilitate the |
| | sharing of data across different |
| | systems, particularly systems connected |
| | via the Internet. Languages based on XML |
| | (for example, RDF, RSS, MathML, XHTML, |
| | SVG, and cXML) are defined in a formal |
| | way, allowing programs to modify and |
| | validate documents in these languages |
| | without prior knowledge of their form. |

To apprise the public of the scope of this invention I make the following claims:

What is claimed is:

1. A method for recording the location of an object, comprising the steps of:
reading an identification tag associated with the object,
recording identification information from the identification tag,
recording spatial coordinates of the object together with the time of recording.

2. The method of claim 1, resulting in an alpha-numeric string encoding the location information, time and the identification information.

3. The method of claim 2, further comprising the step of sending the information to a computer information system.

4. The method of claim 3, in which the location information as stored in a database will further consist of: a hierarchical commodity code, a volatility indicator, a privacy code, and the aggregate count of objects of each given commodity code at this stocking entity location.

5. The method of claim 2, in which the spatial coordinates are selected from a list which may include GPS co-ordinates, latitude/longitude/elevation, aisle/row/shelf/bin, unit/address/city/state, section/row/seat or slot, hall or building/floor/room, map/grid point, military grid point, or district/ward/precinct.

6. A method for physically locating an object, comprising the steps of:
searching a computer database suspected of containing an entry corresponding to said object,
displaying the object information of the computer database entry,
using the object information to physically locate the object.

7. The method of claim 6, in which the computer database entry encodes one or more elements in the group consisting of information such as: object name, object code number, object spatial location, time of recording, object quantity, commodity code, security level, color, size, style, height, weight, length, depth, thread pitch, diameter, material, tempering time, chemical formula, volume, packing coefficient, finish, cost, price, date of manufacture, date of acquisition, shelf life, volatility, packaging, serial number, batch number, contract number, associated tooling, state.

8. The method of claim 7, in which the object information is transferred to a portable unit capable of directing an operator to the physical location of the object based on the object information from the database.

9. A geo locating information tag reading device comprising:
a geo location means,
a tag reading means,
a memory module,
a power supply, and
a communication means;
in which the device is used to record the location of an object.

10. The device of claim 9, further comprising a keyboard interface.

11. The device of claim 9, further comprising a visual display.

12. The device of claim 9, further comprising software algorithms to lead an operator towards a target.

13. A method for information gathering, storage and retrieval by a master network computer, in which the master computer will maintain and publish the index of stored data from its client node(s), and will summarize the objects of the client node(s) by appropriate level of commodity code.

14. The method of claim 13, further comprising routing the queries through a external network to the node that best fills the query specification.

15. A method for identifying a stocking entity location, in which each master node will maintain a standard file having at least a record indicating an entity name, the geo-location data for the stocking entity, and identity information sufficient for users to contact the stocking entity.

16. A method for a hierarchical system of indexes, in which each level is an aggregate of all its subordinate levels, provides for re-aggregation into broader classes by hierarchical code, and provides that the final or root node of said system would be the most general code.

17. A method for information retrieval for use with a system, comprising queries selected from the group consisting of: quantity by location, object code, commodity code, node data and stocking entity data.
